(19) United States
(12) Patent Application Publication
(10) Pub. No.: US 2019/0320477 A1
(43) Pub. Date: Oct. 17, 2019

(54) METHOD FOR PAIRING WITH A GATEWAY

(71) Applicant: SAGEMCOM BROADBAND SAS, Rueil Malmaison (FR)

(72) Inventor: Nicolas KORBER, Rueil Malmaison (FR)

(73) Assignee: SAGEMCOM BROADBAND SAS, Rueil Malmaison (FR)

(21) Appl. No.: 16/343,936

(22) PCT Filed: Oct. 23, 2017
(86) PCT No.: PCT/EP2017/076951

§ 371 Date: Apr. 22, 2019

(30) Foreign Application Priority Data
Oct. 24, 2016 (FR) 16/60301

(51) Int. Cl. H04W 76/15; H04W 76/34; H04W 12/06

(52) U.S. Cl. CPC H04W 76/15; H04W 84/12; H04W 12/0602; H04W 76/34

(57) ABSTRACT

A gateway manages a first secure wireless local network and a second secure wireless local network. The gateway interconnects the second secure wireless local network and a wide-area network so that each device paired with the second secure wireless local network can access services offered by the wide-area network. The gateway detects an attempt at first pairing, with the first secure wireless local network, using first authentication data. The gateway checks with a provisioning server that the first pairing is performed by a device associated with the same user as the gateway, and checks that the first authentication data correspond to expected authentication data. In the case of a positive check, the gateway transmits, via the first secure wireless local network, second authentication data as well as a network identifier of the second secure wireless local network, with a view to pairing with the second secure wireless local network.

The present invention relates to pairing a communication device with a gateway for accessing services offered via a wide-area network thanks to the gateway.

The establishment of wireless local area networks (WLANs) offers great flexibility to the users of communication devices, such as computers, tablets, smartphones, set top boxes (STBs), etc. Such WLANs are for example established by residential gateways made available by internet access providers to users who have taken out a subscription with them.

In order not to enable just any communication device to connect to a WLAN and have access to data exchanges via the WLAN, security protocols are implemented. Ensuring the security of the WLAN must not however take place to the detriment of simplicity of configuration.

For example, in the context of a Wi-Fi (registered trade mark) network, the WPS (Wi-Fi Protected Setup) protocol may be used. The purpose of the WPS protocol is that the configuration phase for securing a Wi-Fi network is simple, and therefore accessible to users without any particular knowledge with regard to communication network configuration. The WPS protocol proposes at least three ways of enabling a communication device to pair with a wireless access point (WAP), namely to recover from said wireless access point WAP encryption keys enabling to communicate in the Wi-Fi (registered trade mark) network in a secure manner: the PIN (personal identification number) pairing procedure, the PBC (push-button configuration) pairing procedure and the NFC (near-field communication) pairing procedure.

The PIN pairing procedure is based on a PIN code supplied by the communication device seeking to connect to the Wi-Fi (registered trade mark) network; this code is then entered by a user via a user interface of the wireless access point WAP. Conversely, it is also possible to enter a PIN code supplied by the wireless access point WAP, via a user interface of the communication device seeking to connect to the Wi-Fi (registered trade mark) network. However, in 2011, the researcher Stefan Viehbock demonstrated an important security leak in the PIN pairing procedure, which now makes it non-recommended.

The PBC pairing procedure is based on the fact that the user presses on a button, whether it be physical or virtual, both on the wireless access point WAP and on the communication device to be connected to the secure Wi-Fi (registered trade mark) network. The PBC pairing procedure is thus such that the wireless access point WAP thus provides, for a period of time of predefined duration and to any communication device so requesting, routine pairing authorisation. This approach, although simple to execute, requires manipulations both on the communication device to be connected to the secure Wi-Fi (registered trade mark) network and on the wireless access point WAP. In addition, this approach also suffers from an important security leak.

The NFC pairing procedure is based on the fact that the user brings the communication device to be connected to the Wi-Fi (registered trade mark) network close to the access point WAP in order to establish a near-field communication. The NFC pairing procedure is thus such that the wireless access point WAP also provides routine pairing authorisation to any communication device so requesting by near-field communication NFC. This approach is particularly practical for small communication devices, e.g. which are held in the hand. This approach is however constraining with regard to mains-powered devices that the user wishes to install at a distance from the wireless access point WAP, e.g. in order to install a set top box STB made available by the internet access provider that also supplied to the user in question the residential gateway RGW acting as a wireless access point WAP.

It is desirable to overcome these drawbacks of the prior art. It is thus desirable to provide a solution that is even more simple from the user point of view, and which is secure. It is in particular desirable to provide a solution that avoids requesting the user to have to carry out manipulations both on the residential gateway RGW acting as the wireless access point WAP and on the communication device to be connected to the wireless network WLAN.

The invention relates to a pairing method implemented by a gateway serving as a wireless access point to at least one first secure wireless local network and to a second secure wireless local network, the gateway interconnecting the second secure wireless local network and a wide-area network so that each communication device paired with the second secure wireless local network can access services offered via the wide-area network, a provisioning server being connected to the wide-area network. The method is such that it comprises the following steps: detecting an attempt at first pairing of a communication device with one said first secure wireless local network, in which the communication device is identified and supplies first authentication data; checking with the provisioning server that said communication device is associated with the same user as the gateway and checking that the first authentication data correspond to authentication data expected by the gateway vis-à-vis said first secure wireless local network; in the case of a positive check, confirming the first pairing with said first secure wireless local network and transmitting, to said communication device via said first secure wireless local network, second authentication data as well as a network identifier of the second secure wireless local network; detecting an attempt at second pairing of the communication device with the second secure wireless local network, in which the communication device supplies other authentication data; checking that said other authentication data correspond to said second authentication data; and, in the case of positive check, confirming the second pairing with the second secure wireless local network, so as to enable said communication device to access said services offered by the wide-area network. Thus, by relying on this first secure wireless local network, the pairing can be performed without any manipulation by the user. The approach proposed allows not to have to communicate in the factory, when producing devices able to be subsequently paired with the second secure wireless local network, the authentication data of said second secure wireless local network (which would make it necessary to produce and configure these devices on request, so as to be customised for each user). The pairing of a communication device (e.g. a set top box device) for accessing the services (e.g. IPTV) offered via the wide-area network is thus simple when said communication device is supplied to the user by the internet access provider that provided the gateway.

According to a particular embodiment, for checking that said communication device is associated with the same user as the gateway and to check that the first authentication data correspond to the authentication data expected, the gateway receives from the provisioning server a description including, for each communication device among a set of communication devices liable to pairing: a communication device identifier, a network identifier, and authentication data expected vis-à-vis the first secure wireless local network. In addition, the gateway creates one said first secure wireless local network for each communication device among said set of communication devices liable to pairing, by allocating to said first secure wireless local network the network identifier of the description of the corresponding communication device. Thus, the first secure wireless local network is specialised for each communication device identified as liable to pairing (supplied to the user by the internet access provider that supplied the gateway). Pairing security is thus reinforced.

According to a particular embodiment, when the second pairing with the second secure wireless local network for a communication device among said set of communication devices liable to pairing is confirmed, the gateway stops the first secure wireless local network created for said communication device. Pairing security is thus further reinforced, and savings on resources are made.

According to a particular embodiment, to check that said communication device is associated with the same user as the gateway and to check that the first authentication data correspond to the expected authentication data, the gateway receives from the provisioning server a description including, for each communication device among a set of communication devices liable to pairing: a communication device identifier. In addition, the gateway creates a single first secure wireless local network, by allocating a generic network identifier to said first secure wireless local network and using default authentication data as expected authentication data. Thus, management of the provisioning server is simplified.

According to a particular embodiment, each first secure wireless local network and the second secure wireless local network are of the Wi-Fi type. Thus, the invention can benefit from a wide panel of products used personally and/or professionally.

The invention also relates to a pairing method implemented by a communication device vis-à-vis a first secure wireless local network and a second secure wireless local network, the second secure wireless local network being interconnected with a wide-area network thanks to a gateway so that each communication device paired with the second secure wireless local network can access services offered via the wide-area network, a provisioning server being connected to the wide-area network. The method is such that it comprises the following steps: performing with the gateway an attempt at first pairing with the first secure wireless local network, in which the communication device is identified and supplies first authentication data stored in the memory of said communication device, and identifying the first secure wireless local network thanks to a network identifier also stored in the memory of said communication device; in the event of success of the first pairing, receiving from the gateway, via the first secure wireless local network, second authentication data, as well as a network identifier of the second secure wireless local network; and performing a second pairing with the second secure wireless local network using the second authentication data received from the gateway, by identifying the second secure wireless local network thanks to the network identifier supplied by the gateway.

According to a particular embodiment, the communication device is a set top box configured to access services of the IPTV type via the wide-area network thanks to said gateway.

According to a particular embodiment, each first secure wireless local network and the second secure wireless local network are of the Wi-Fi type.

The invention also relates to a gateway configured to serve as a wireless access point to at least one first secure wireless local network and to a second secure wireless local network, the gateway interconnecting the second secure wireless local network and a wide-area network so that each communication device paired with the second secure wireless local network can access services offered via the wide-area network, a provisioning server being connected to the wide-area network. The gateway is such that it comprises: means for detecting an attempt at first pairing of a communication device with one said first secure wireless local network, in which the communication device is identified and supplies first authentication data; means for checking with the provisioning server that said communication device is associated with the same user as the gateway and checking that the first authentication data correspond to authentication data expected by the gateway vis-à-vis said first secure wireless local network; means for confirming, in the case of a positive check, the first pairing with said first secure wireless local network and for transmitting to said communication device via said first secure wireless local network second authentication data as well as a network identifier of the second secure wireless local network; means for detecting an attempt at second pairing of the communication device with the second secure wireless local network, in which the communication device supplies other authentication data; means for checking that said other authentication data correspond to said second authentication data; and means for confirming, in the case of a positive check, the second pairing with the second secure wireless local network, so as to enable said communication device to access said services offered via the wide-area network.

The invention also relates to a communication device configured for pairing vis-à-vis a first secure wireless local network and a second secure wireless local network, the second secure wireless local network being interconnected with a wide-area network thanks to a gateway so that each communication device paired with a second secure wireless local network can access services offered via the wide-area network, a provisioning server being connected to the wide-area network. The communication device is such that it comprises: means for perfoming, with the gateway, an attempt at first pairing with the first secure wireless local network, in which the communication device is identified and supplies first authentication data stored in the memory of said communication device, and identifying the first secure wireless local network thanks to a network identifier also stored in the memory of said communication device; means for receiving, in the case of success of the first pairing, from the gateway via the first secure wireless local network, second authentication data as well as a network identifier of the second secure wireless local network; and means for performing a second pairing with the second secure wireless local network using the second authentication data received from the gateway, by identifying the second secure wireless local network thanks to the network identifier supplied by the gateway.

According to a particular embodiment, the communication device is a set top box configured to access IPTV services via the wide-area network thanks to said gateway.

The invention also relates to a computer program that can be stored on a medium and/or downloaded from a communication network in order to be read by a processor. This computer program comprises instructions for implementing one or other of the methods mentioned above in any of the embodiments thereof when said program is executed by the processor. The invention also relates to an information storage medium storing such a computer program.

The features of the invention mentioned above, as well as others, will emerge more clearly from a reading of the following description of an example embodiment, said description being given in relation to the accompanying drawings, among which:

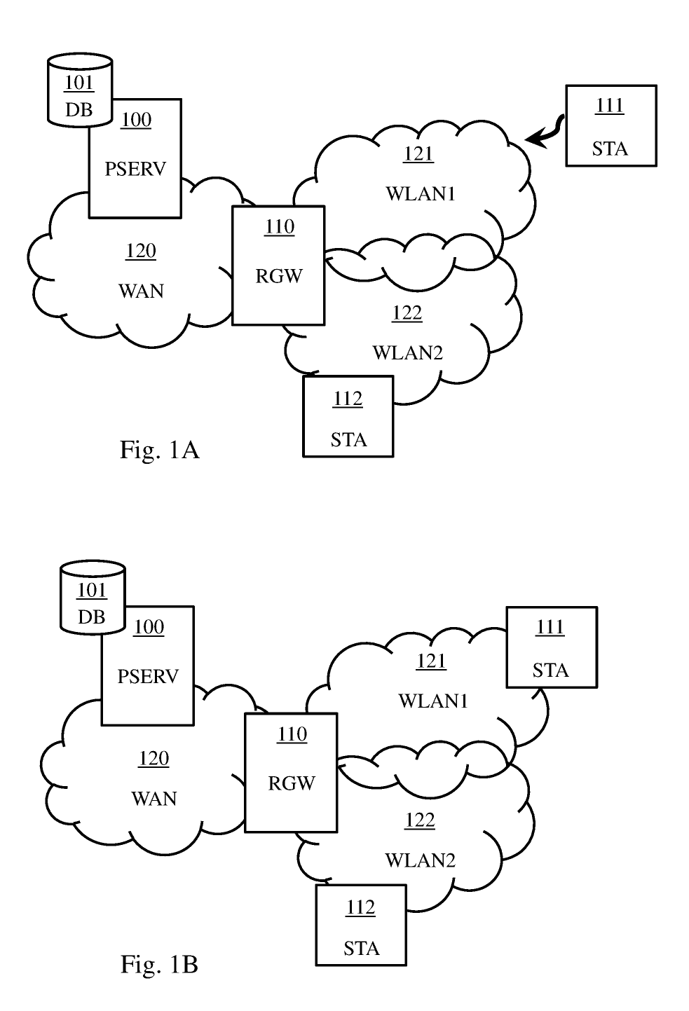

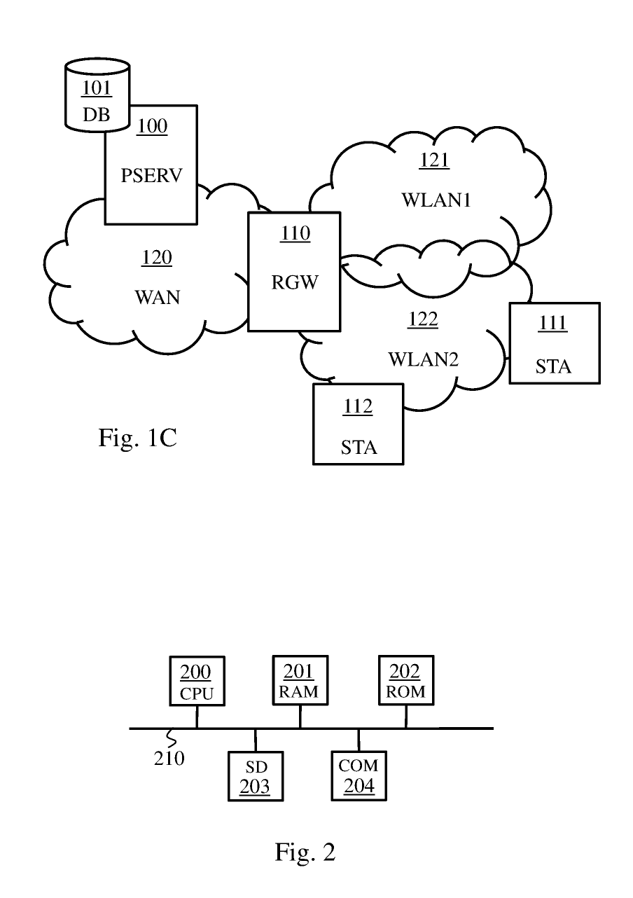

FIGS. 1A to 1C illustrate schematically a development of a configuration of a wireless communication system in which the present invention is implemented;

FIG. 2 illustrates schematically an example of hardware architecture of a gateway of said wireless communication system;

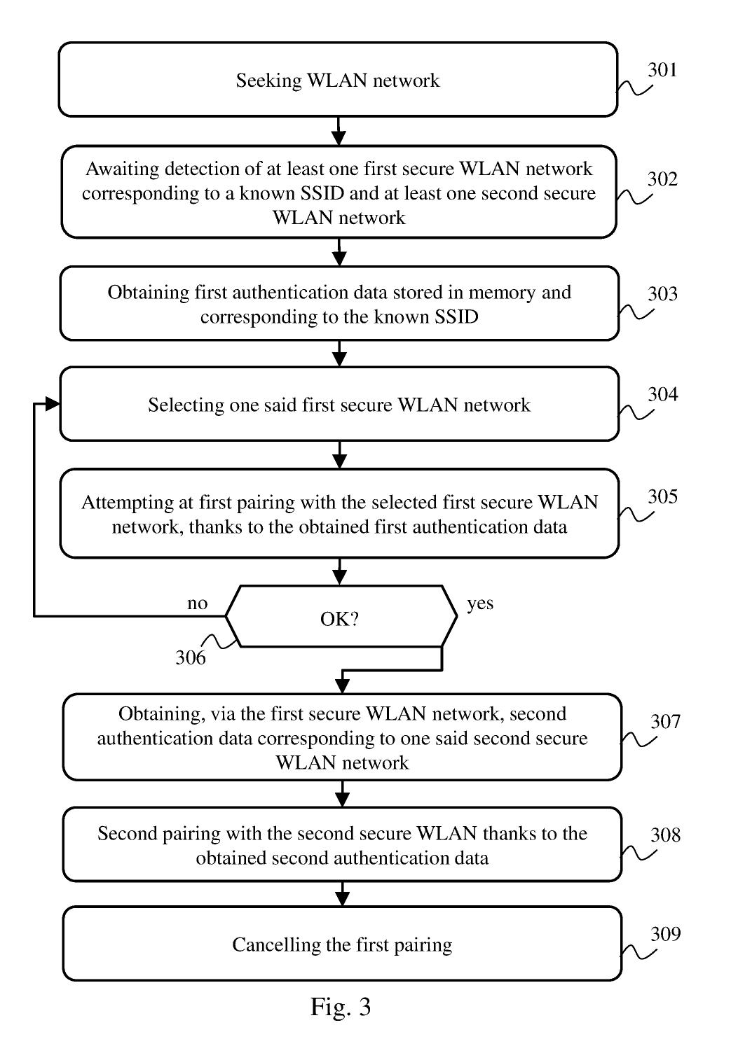

FIG. 3 illustrates schematically a pairing algorithm implemented by a communication device;

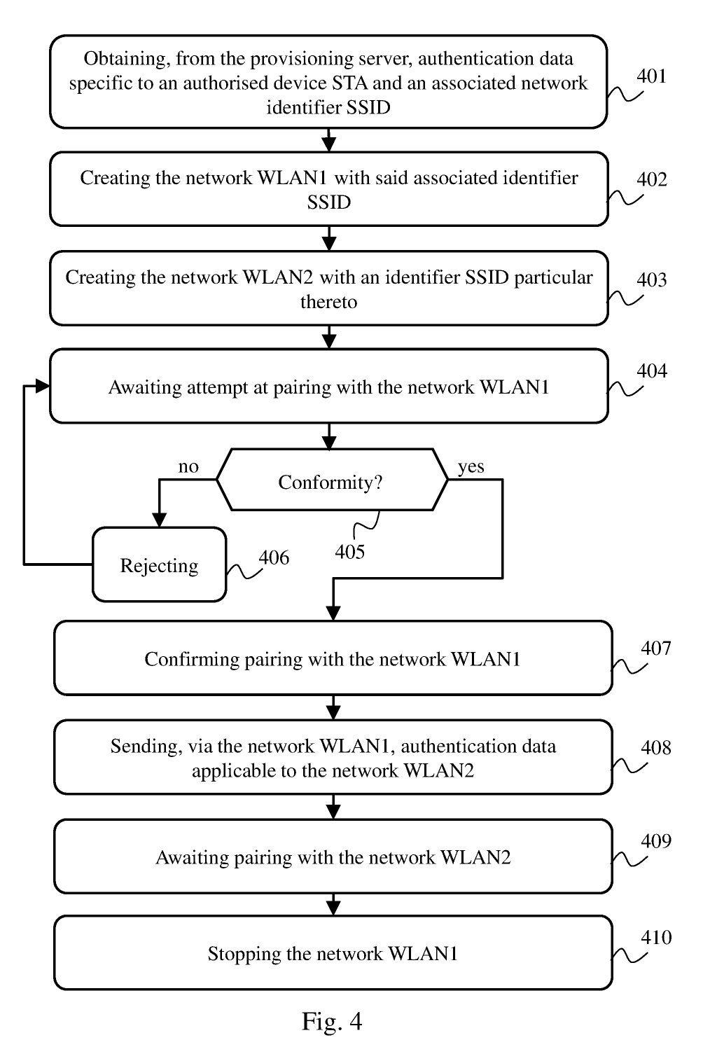

FIG. 4 illustrates schematically a pairing algorithm implemented by said gateway, according to a first embodiment of the invention; and

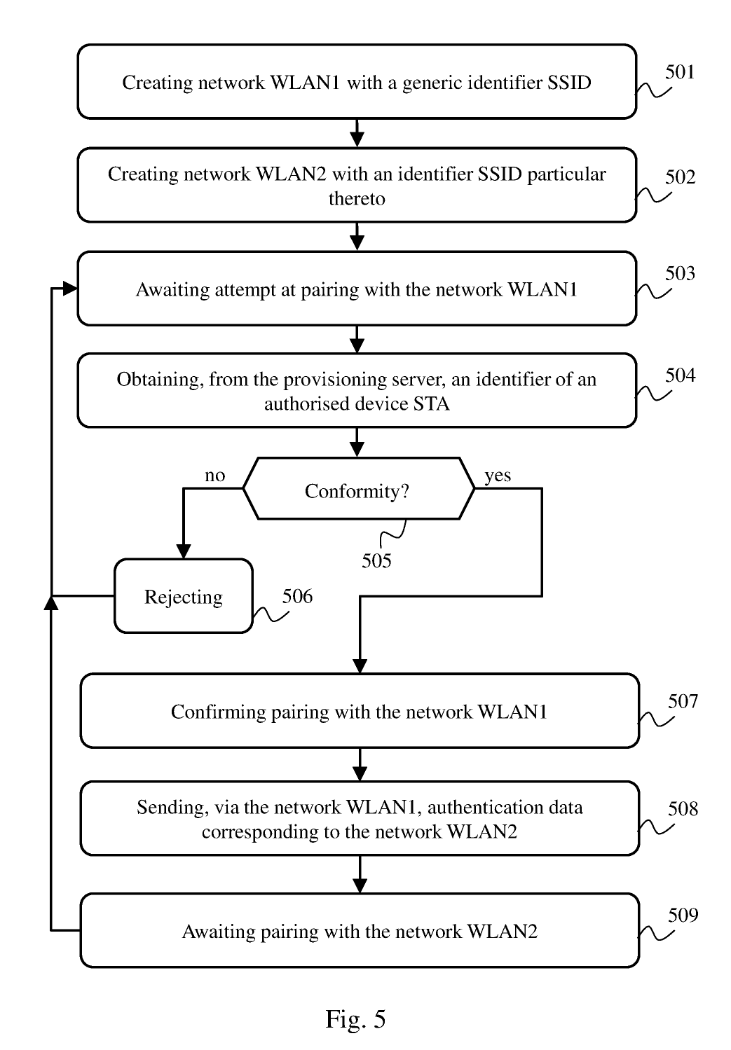

FIG. 5 illustrates schematically a pairing algorithm implemented by said gateway according to a second embodiment of the invention.

FIG. 1A illustrates schematically a wireless communication system comprising a gateway, such as for example a residential gateway RGW 110, and a provisioning server PSERV 100 typically forming part of an operational support system OSS.

The gateway RGW 110 is configured to communicate with the provisioning server PSERV 100 via a wide-area network WAN 120, which is typically the internet. For example, the gateway RGW 110 communicates with the provisioning server PSERV 100 using the SNMP (Simple Network Management Protocol, as defined in the normative document RFC 1157), or the TR-069 protocol, also referred to as CWMP (CPE WAN Management Protocol, where CPE means customer-premises equipment).

The gateway RGW 110 is configured to create and manage at least two secure wireless local networks WLAN. Each of these wireless local networks WLAN is secure in that pairing with said wireless local network WLAN requires that any communication device wishing to communicate via said wireless local network WLAN is authenticated thanks to authentication data. These authentication data are typically a pre-shared secret, also referred to as a pre-shared key PSK, known to the gateway RGW 110 by another means, and which said communication device shall communicate to the gateway RGW 110 in order to be authenticated.

Let us consider that the gateway RGW 110 creates and manages a secure wireless local network WLAN1 121 and a secure wireless local network WLAN2 122. The gateway RGW 110 thus has the role of wireless access point WAP vis-à-vis the secure wireless local network WLAN1 121 and the secure wireless local network WLAN2 122. The secure wireless local network WLAN1 121 and the secure wireless local network WLAN2 122 are preferentially secure wireless local networks WLAN of the Wi-Fi (registered trade mark) type.

The secure wireless local network WLAN1 121 has a network identifier, called SSID (service set identifier) in accordance with Wi-Fi (registered trade mark) terminology, which is distinct from another network identifier allocated to the secure wireless local network WLAN2 122. The gateway RGW 110, in its role of wireless access point, broadcasts the network identifier of each of these secure wireless local networks WLAN in respective beacons.

The secure wireless local network WLAN2 122 is intended to enable the user to access services offered via the wide-area network WAN 120 by the internet access provider. The user then uses wireless communication devices, such as tablets or set top boxes STB, which are connected to the secure wireless local network WLAN2 122 for accessing these services (web browser, viewing on-demand audiovisual content, etc.), the gateway RGW 110 then serving as a relay between the wide-area network WAN 120 and the secure wireless local network WLAN2 122. In other words, the gateway RGW 110 serves as an interconnection device between the wide-area network WAN 120 and the secure wireless local network WLAN2 122. FIG. 1A shows a wireless communication device 112, also referred to as a station STA, connected to the wireless local network WLAN2 122 and therefore paired with the secure wireless local network WLAN2 122.

As detailed hereinafter, the secure wireless local network WLAN1 121 is intended to facilitate pairing operations with the secure wireless local network WLAN2 122 for wireless communication devices supplied by the internet access provider to the user, such as for example one or more set top boxes STB for accessing IPTV (Internet Protocol television) services. The secure wireless local network WLAN1 121 is therefore considered to be a management tool, and preferentially the gateway RGW 110 does not perform any interconnection between the wide-area network WAN 120 and the secure wireless local network WLAN1 121. In other words, the gateway RGW 110 does not enable the user to access, thanks to the secure wireless local network WLAN1 121, the services offered via the wide-area network WAN 120 by the internet access provider. FIG. 1A shows a wireless communication device 111, also referred to as a station STA, which was supplied by the internet access provider that also supplied the gateway RGW 110 and which seeks to pair with the secure wireless local network WLAN1 121, in order to be paired ultimately with the secure wireless local network WLAN2 122.

The provisioning server PSERV 100 comprises, or is connected to, a database DB 101. The database DB 101 stores a subscription description for each user who has taken out a subscription with the internet access provider with which the operational support system OSS is associated. The database DB 101 stores, for each user, an identifier (e.g. MAC (medium access control) address) associated with each device that was supplied by the internet access provider to said user in the context of his subscription. The database DB 101 thus in particular stores, for each user, an identifier associated with a gateway RGW that was supplied by the internet access provider to said user in the context of his subscription. The database DB 101 also thus stores, for each user, an identifier associated with each other device that was supplied by the internet access provider to said user and which is liable to being subsequently paired with the secure wireless local network WLAN2 122 in order to benefit from the services offered via the wide-area network WAN 120 by the internet access provider As dealt with hereinafter, the database DB 101 can store, for each user, other information relating to each device that was supplied by the internet access provider to said user.

FIG. 1B illustrates schematically a development of the wireless communication system in which the device STA 111 has succeeded in connecting to the secure wireless local network WLAN1 121 and being paired with the secure wireless local network WLAN1 121. The pairing with the secure wireless local network WLAN1 121 is achieved thanks to first authentication data that were previously stored in the memory of the device STA 111, for example by configuration in the factory or by connection to the device STA 111 of an external memory storing said first authentication data. As detailed hereinafter, in order to be able to perform the pairing of the device STA 111 with the secure wireless local network WLAN1 121, the gateway RGW 110 obtains, from the provisioning server PSERV 100, information enabling to ensure that the device STA 111 is entitled to be paired with the wireless local network WLAN1 121 in order then to receive second authentication data enabling pairing with the secure wireless local network WLAN2 122.

FIG. 1C illustrates schematically a subsequent development of the wireless communication system in which the device STA 111 has succeeded in being paired with the secure wireless local network WLAN2 122 thanks to the second authentication data obtained by the device STA 111 via the secure wireless local network WLAN1 121. The device STA 111 is then in a position to access the services offered via the wide-area network WAN 120 by the internet access provider.

An algorithm implemented by the device STA 111, allowing the development of the wireless communication system presented in FIGS. 1A to 1C, is described hereinafter in relation to FIG. 3. A first embodiment of an algorithm, implemented by the gateway RGW 110, allowing development of the wireless communication system presented in FIGS. 1A to 1C, is described below in relation to FIG. 4. A second embodiment of the algorithm, implemented by the gateway RGW 110, allowing the development of the wireless communication system presented in FIGS. 1A to 1C, is described hereinafter in relation to FIG. 5.

FIG. 2 illustrates schematically an example of hardware architecture of the gateway RGW 110.

The gateway RGW 110 then comprises, connected by a communication bus 210: a processor or CPU (central processing unit) 200; a random access memory (RAM) 201; a read only memory (ROM) 202; a storage unit or a storage medium reader, such as an SD (secure digital) card reader 203 or a hard disk drive (HDD); and a set of communication interfaces COM 204, enabling in particular the gateway RGW 110 to communicate via the wide-area network WAN 120, and to manage the secure wireless local network WLAN1 122 and the secure wireless local network WLAN2 122.

The processor 200 is capable of executing instructions loaded in the RAM 201 from the ROM 202, from an external memory (such as an SD card), from a storage medium (such as a hard disk HDD), or from a communication network (such as the wide-area network WAN 120). When the gateway RGW 110 is powered up, the processor 200 is capable of reading instructions from the RAM 201 and executing them. These instructions form a computer program causing the implementation, by the processor 200, of all or some of the algorithms and steps described below in relation to the gateway RGW 110.

Thus all or some of the algorithms and steps described below in relation to the gateway RGW 110 can be implemented in software form by the execution of a set of instructions by a programmable machine, such as a DSP (digital signal processor) or a microcontroller. All or some of the algorithms and steps described below can also be implemented in hardware form by a machine or a dedicated component, such as an FPGA (field-programmable gate array) or an ASIC (application-specific integrated circuit).

It should be noted that the device STA 111 may follow the same hardware architecture and the provisioning server PSERV 100 may also follow the same hardware architecture.

FIG. 3 illustrates schematically a pairing algorithm implemented by the device STA 111, in the context of the present invention.

In a step 301, the device STA 111 activates a search for WLAN networks within radio range. For example, the device STA 111 listens out for beacons transmitted by wireless access points WAP within radio range of the device STA 111. According to another example, the device STA 111 transmits a probe request message requesting each wireless access point WAP within radio range of the device STA 111 to announce, in a probe response message, each wireless local network WLAN made available by said wireless access point WAP.

In a step 302, the device STA 111 awaits detection of at least one first secure wireless local network WLAN having a network identifier SSID known to the device STA 111. This network identifier was stored previously in the memory of the device STA 111, for example by configuration in the factory or by connection to the device STA 111 of an external memory storing said network identifier.

In step 302, the device STA 111 is supposed to detect also at least one second secure wireless local network WLAN. Otherwise this means that the device STA 111 is not geographically at a suitable place.

Let us consider at this moment that the device STA 111 is within radio range of the gateway RGW 110 and therefore in the coverage area of the secure wireless local network WLAN1 121 and of the secure wireless local network WLAN2 122. Let us consider also that the network identifier SSID of the secure wireless local network WLAN1 121 corresponds to the one sought by the device STA 111. This aspect is dealt with once again below in relation to FIGS. 5 and 6.

In a step 303, the device STA 111 obtains first authentication data corresponding to said network identifier SSID that was already known to the device STA 111 at the starting of the algorithm in FIG. 3. These first authentication data were also stored previously in the memory of the device STA 111, for example also by configuration in the factory or by connection to the device STA 111 of an external memory storing said first authentication data.

These first authentication data enable the device STA 111, supplied by the internet access provider that also supplied the gateway RGW 110, to be authenticated in the context of pairing with the secure wireless local network WLAN1 121. Preferentially, these first authentication data are a secret. These first authentication data may be accompanied by an associated type of encryption (for example WPA (Wi-Fi protected access) or WPA2).

In a step 304, the device STA 111 selects a first secure wireless local network WLAN from the first secure wireless local networks WLAN that were detected at step 302.

Indeed, it may happen that a plurality of wireless local networks WLAN have the same network identifier SSID, or even that the same authentication data are applicable via various secure wireless local networks WLAN having this same network identifier SSID. This aspect is dealt with once again below in relation to FIG. 6.

In a step 305, the device STA 111 performs an attempt at a first pairing with the first secure wireless local network WLAN selected at step 304. In other words, the device STA 111 transmits, to the access point WAP managing the first secure wireless local network WAN selected at step 304, the first authentication data stored in the memory of the device STA 111 corresponding to the network identifier SSID in question. Typically, the device STA 111 transmits the pre-shared key PSK already mentioned. Each message sent by the device STA 111 in this attempt at first pairing identifies the device STA 111 unambiguously as the source of said message (e.g. thanks to its MAC address).

In a step 306, the access point WAP managing the first secure wireless local network WLAN selected at step 304 responds to the device STA 111 and the device STA 111 checks whether the attempt at first pairing performed at step 305 was successful. If such is the case (which means that the first secure wireless local network WLAN is actually the secure wireless local network WLAN1 121 managed by the gateway RGW 111), a step 307 is performed; otherwise step 304 is reiterated, selecting another secure wireless local network WLAN the network identifier SSID of which corresponds to the one sought by the device STA 111. If all the first secure wireless local networks WLAN that were detected at step 304 have been reviewed, step 301 is reiterated, seeking at least one other secure wireless local network WLAN the network identifier SSID of which corresponds to the one sought by the device STA 111 (not shown in FIG. 3).

In step 307, the device STA 111 obtains, via the first secure wireless local network WLAN with which the device STA 111 is now paired (i.e. the secure wireless local network WLAN1 121), second authentication data applicable to a second secure wireless local network WLAN (i.e. the secure wireless local network WLAN2 122) established by the same gateway RGW (i.e. the gateway RGW 110). These second authentication data are accompanied by the network identifier SSID of the secure wireless local network WLAN2 122. As detailed hereinafter in relation to FIGS. 5 and 6, the fact that the first pairing was successful ensures that the device STA 111 has actually been supplied to the same user as the gateway RGW in question (i.e. the gateway RGW 110).

These second authentication data enable the device STA 111 to be authenticated in the context of pairing with the secure wireless local network WLAN2 122. Preferentially, these second authentication data are a secret. These second authentication data may be accompanied by an associated type of encryption (for example WPA or WPA2).

These second authentication data and the network identifier SSID that accompanies them are preferentially transmitted to the device STA 111 in accordance with a proprietary protocol, based for example on the TCP (transmission control protocol) or on the SNMP protocol.

In a step 308, the device STA 111 performs a second pairing with the second wireless local network WLAN in question. In other words, the device STA 111 transmits, to the gateway RGW managing the second secure wireless local network WLAN in question, the second authentication data received at step 307. Typically, the device STA 111 transmits the pre-shared key PSK already mentioned. The pairing is supposed to take place successfully, given that these second authentication data were transmitted by the gateway RGW concerned (i.e. the gateway RGW 110) to enable the device STA 111 to be authenticated in the context of pairing with the secure wireless local network WLAN2 122. The device STA 111 is then in a position to access the services offered via the wide-area network WAN 120 by the internet access provider.

In an optional step 309, the device STA 111 disconnects from the wireless local network WLAN1 121 and cancels the first pairing.

FIG. 4 illustrates schematically a pairing algorithm implemented by the gateway RGW 110, according to a first embodiment of the invention. In this first embodiment, it is considered that each communication device STA supplied by the internet access provider has its own authentication data (first authentication data in the context of the algorithm in FIG. 3). Typically, each communication device STA supplied by the internet access provider stores in memory a pre-shared key PSK that is particular to it, which was for example generated randomly in production. In addition, it is considered that each communication device STA supplied by the internet access provider stores in memory a network identifier SSID (for which said authentication data are applicable) that is particular to it.

In a step 401, the gateway RGW 110 obtains, from the provisioning server PSERV 100, a description associated with each communication device STA supplied by the internet access provider to the same user as the gateway RGW 110. The internet access provider therefore keeps the database DB 101 up to date so that the subscription device for each user indicates each communication device STA supplied by the internet access provider to said user. The provisioning server PSERV 100 can identify which user is concerned on the basis of the identifier of the gateway RGW 110. The description received at step 401 includes an identifier (e.g. MAC address) of the communication device STA in question. The description received at step 401 in addition authentication data that are applicable to said communication device STA in the context of the pairing with the secure wireless local network WLAN1 121, as well as a network identifier SSID with which said communication device STA expects to have to use said authentication data (these are therefore the first authentication data as used in the context of the algorithm in FIG. 3).

Step 401 is for example triggered when the gateway RGW 110 is powered up or when the gateway RGW 110 is reinitialised. Step 401 may also be triggered on reception of a message from the provisioning server PSERV 100, for example when the internet access provider supplies a new communication device STA to the same user as the gateway RGW 110. Step 401 may also be triggered by regular interrogation of the provisioning server PSERV 100 by the gateway RGW 110 and detection that the internet access provider has supplied a new communication device STA to the same user as the gateway RGW 110. Let us consider by way of illustration that only one communication device STA has been supplied to said user in addition to the gateway RGW 110.

In a step 402, the gateway RGW 110 creates the wireless local network WLAN1 121, by allocating thereto the network identifier SSID mentioned in the description received at step 401. If a plurality of communication devices STA have been supplied to said user in addition to the gateway RGW 110 (and therefore liable to pairing), the gateway RGW 110 thus creates a wireless local network WLAN1 121 for each of these communication devices STA.

In a step 403, the gateway RGW 110 creates the wireless local network WLAN2 122, by allocating thereto a network identifier SSID that is particular thereto (typically this network identifier SSID is also inscribed on the casing of the gateway RGW 110). The network identifier SSID of the wireless local network WLAN2 122 is typically entered in the memory of the gateway RGW 110 in the factory, but may also be modified by the user thanks to a configuration portal exported by a web server installed by the gateway RGW 110.

It should be noted that the wireless local network WLAN2 122 may entirely be created before the wireless local network WLAN1 121.

In a step 404, the gateway RGW 110 awaits an attempt at first pairing with the wireless local network WLAN1 121. The gateway RGW 110 therefore awaits to receive first authentication data that should allow pairing a communication device STA that was supplied to said user by the internet access provider.

In a step 405, the gateway RGW 110 has detected an attempt at first pairing with the wireless local network WLAN1 121. The gateway RGW 110 analyses whether this attempt at first pairing comes from a communication device STA that corresponds to the one the description of which was obtained at step 401 and which is associated with the network identifier SSID of the wireless local network WLAN1 121 according to said description. In its attempt at pairing, the communication device STA in question is identified and has supplied first authentication data that are supposed to correspond to those supplied in the description received at step 401. If such is the case, the gateway RGW 110 considers that the attempt at first pairing with the wireless local network WLAN1 121 is in conformity and a step 407 is then performed. Otherwise the gateway RGW 110 considers that the attempt at first pairing with the wireless local network WLAN1 121 is not conforming, and a step 406 is then performed.

In step 406, the gateway RGW 110 rejects the first pairing with the wireless local network WLAN1 121 and informs thereof the communication device STA in question. The gateway RGW 110 then once again awaits an attempt at first pairing with the wireless local network WLAN1 121, by reiterating step 404.

In step 407, the gateway RGW 110 accepts the first pairing with the secure wireless local network WLAN1 121 and confirms the success of the first pairing to the communication device STA in question. The fact that the first pairing has been successful ensures that the device STA in question has actually been supplied to the same user as the gateway RGW 110, since said communication device STA was explicitly identified in the description received at step 401.

In a step 408, the gateway RGW 110 sends second authentication data to the communication device STA in question via the secure wireless local network WLAN1 121. These second authentication data are accompanied by the network identifier SSID of the secure wireless local network WLAN2 122.

These second authentication data enable the communication device STA in question to be authenticated in the context of the pairing with the secure wireless local network WLAN2 122. Preferentially, these second authentication data are a secret. These second authentication data may be accompanied by an associated type of encryption (for example WPA or WPA2).

As already mentioned, these second authentication data and the network identifier SSID that accompanies them are preferentially transmitted to the communication device STA in question in accordance with a proprietary protocol, based for example on the TCP protocol or on the SNMP protocol.

In a step 409, the gateway RGW 110 awaits a second pairing with the secure wireless local network WLAN2 122. The communication device STA in question is supposed to use the second authentication data transmitted at step 408. If such is the case, an optional step 410 is implemented. Otherwise step 409 is reiterated (not shown in FIG. 4).

In the optional step 410, the gateway RGW 110 stops the secure wireless local network WLAN1 121 (no further communication device STA is supposed to attempt to perform a pairing with a secure wireless local network WLAN having the identifier SSID that was used to identify the secure wireless local network WLAN1 121).

If a plurality of communication devices STA have been supplied to said user in addition to the gateway RGW 110 (and therefore liable to pairing), the gateway RGW 110, in step 410, stops the wireless local network WLAN1 121 that has been created for the communication device STA the second pairing of which succeeded. Step 404 is then reiterated (awaiting another communication device STA liable to pairing, if one such remains).

FIG. 5 illustrates schematically a pairing algorithm implemented by the gateway RGW 110, according to a second embodiment of the invention. In this second embodiment, it is considered that all the devices STA supplied by the internet access provider have the same authentication data (first authentication data in the context of the algorithm in FIG. 3). Typically, all the communication devices STA supplied by the internet access provider store in memory the same pre-shared key PSK. In addition, it is considered that all the communication devices STA supplied by the internet access provider store in memory the same network identifier SSID (for which said authentication data are applicable).

In a step 501, the gateway RGW 110 creates the wireless local network WLAN1 121, by allocating thereto a generic network identifier SSID. This generic network identifier SSID is entered in the memory of the gateway RGW 110, for example by configuration in the factory. Each gateway RGW supplied by the internet access provider has this same generic network identifier SSID. It is this same network identifier SSID that is known to all the communication devices STA supplied by the internet access provider, in the context of this second embodiment. Step 501 is for example triggered when the gateway RGW 110 is powered up or when the gateway RGW 110 is reinitialised.

In a step 502, the gateway RGW 110 creates the wireless local network WLAN2 122, by allocating thereto a network identifier SSID that is particular to it (typically this network identifier SSID is also inscribed on the casing of the gateway RGW 110). The network identifier SSID of the wireless local network WLAN2 122 is typically entered in the memory of the gateway RGW 110 in the factory, but may also be modified by the user thanks to a configuration portal exported by a web server installed by the gateway RGW 110.

It should be noted that the wireless local network WLAN2 122 may entirely be created before the wireless local network WLAN1 121.

In a step 503, the gateway RGW 110 awaits an attempt at first pairing with the wireless local network WLAN1 121. The gateway RGW 110 therefore waits to receive first authentication data that should allow pairing a communication device STA that was supplied to said user by the internet access provider.

In a step 504, the gateway RGW 110 has detected an attempt at first pairing with the wireless local network WLAN1 121. The gateway RGW 110 obtains, from the provisioning server PSERV 100, a description associated with each communication device STA supplied by the internet access provider to the same user as the gateway RGW 110. The provisioning server PSERV 100 can identify which user is concerned on the basis of the identifier of the gateway RGW 110. The internet access provider therefore keeps the database DB 101 up to date so that the subscription description for each user indicates each communication device STA supplied by the internet access provider to said user. The description received at step 401 includes an identifier (e.g. an MAC address) of the communication device STA in question.

Step 504 may also be triggered, independently of the algorithm in FIG. 5, on reception of a message from the provisioning server PSERV 100, for example when the internet access provider supplies a new communication device STA to the same user as the gateway RGW 110. Step 504 may also be triggered by regular interrogation of the provisioning server PSERV 100 by the gateway RGW 110 and detection that the internet access provider has supplied a new communication device STA to the same user as the gateway RGW 110.

In a step 505, the gateway RGW 110 analyses whether this attempt at first pairing comes from a communication device STA that corresponds to the one the description of which was obtained at step 504. In its attempt at pairing, the communication device STA in question supplied first authentication data that are supposed to correspond to default authentication data known to the gateway RGW 110. These default authentication data are entered in the memory of the gateway RGW 110, for example by configuration in the factory, just like the aforementioned generic network identifier SSID. Each gateway RGW supplied by the internet access provider has these same default authentication data.

If this attempt at first pairing comes from a communication device STA that corresponds to the one the description of which was obtained at step 504, the gateway RGW 110 considers that the attempt at first pairing with the wireless local network WLAN1 121 is in conformity, and a step 507 is then performed. Otherwise the gateway RGW 110 considers that the attempt at first pairing with the wireless local network WLAN1 121 is not in conformity, and a step 506 is then performed.

In step 506, the gateway RGW 110 rejects the first pairing with the wireless local network WLAN1 121, and informs thereof the communication device STA in question. The gateway RGW 110 then once again awaits an attempt at first pairing with the wireless local network WLAN1 121, by reiterating step 503.

In step 507, the gateway RGW 110 accepts the first pairing with the secure wireless local network WLAN1 121 and confirms the success of the first pairing to the communication device STA in question. The fact that the first pairing was successful ensures that the device STA in question is actually being supplied to the same user as the gateway RGW 110, since said communication device STA was explicitly identified in the description received at step 504.

In a step 508, the gateway RGW 110 sends second authentication data to the communication device STA in question via the secure wireless local network WLAN1 121. These second authentication data are accompanied by the network identifier SSID of the secure wireless local network WLAN2 122.

These second authentication data enable the communication device STA in question to be authenticated in the context of the pairing with the secure wireless local network WLAN2 122. Preferentially, these second authentication data are a secret. These second authentication data may be accompanied by an associated type of encryption (for example WPA or WPA2).

As already mentioned, these second authentication data and the network identifier SSID that accompanies them are preferentially transmitted to the communication device STA in question in accordance with a proprietary protocol, based for example on the TCP protocol or on the SNMP protocol.

In a step 509, the gateway RGW 110 awaits a second pairing with the secure wireless local network WLAN2 122. The communication device STA in question is supposed to use the second authentication data transmitted at step 508. If such is the case, step 503 is reiterated (while awaiting another communication device STA liable to pairing, if such a one remains). Otherwise step 506 is performed (not shown in FIG. 5).

When the second embodiment dealt with in relation to FIG. 5 is implemented, it may happen that a communication device STA supplied to a user detects a plurality of secure wireless local networks WLAN that are identified by the aforementioned generic network identifier SSID. This situation occurs for example when neighbours are using gateways RGW coming from the same internet access provider. This situation is resolved by the checks performed by the gateways RGW in the context of the aforementioned attempts at first pairing. Indeed, each of the gateways RGW checks with the provisioning server PSERV 100 that the identifier (e.g. the MAC address) of each communication device STA that is performing an attempt at pairing actually corresponds to an identifier of a communication device STA that was supplied to the same user as the gateway RGW in question. It is then ensured that a user cannot by error perform a pairing as described with the gateway RGW of his neighbour.

1. A pairing method, wherein a gateway serves as a wireless access point to at least one first secure wireless local network and to a second secure wireless local network, the gateway interconnecting the second secure wireless local network and a wide-area network so that each communication device paired with the second secure wireless local network can access services offered via the wide-area network, a provisioning server being connected to the wide-area network, the method comprising:
detecting an attempt at first pairing of a communication device with one said first secure wireless local network, in which the communication device is identified and supplies first authentication data;
checking that the first authentication data correspond to authentication data expected by the gateway vis-à-vis said first secure wireless local network;
in the case of positive check, confirming the first pairing with said first secure wireless local network and transmitting, to said communication device via said first secure wireless local network, second authentication data as well as a network identifier of the second secure wireless local network;
detecting an attempt at second pairing of the communication device with the second secure wireless local network, in which the communication device supplies other authentication data;
checking that said other authentication data correspond to said second authentication data; and,
in the case of positive check, confirming the second pairing with the second secure wireless local network, so as to enable said communication device to access said services offered by the wide-area network,
wherein the first secure wireless local network does not enable to access the services offered by the wide-area network, and the method is implemented by the gateway and further comprises, for confirming the first pairing with said first secure wireless local network:
checking with the provisioning server that said communication device is associated with the same user as the gateway,
and, for checking that said communication device is associated with the same user as the gateway and for checking that the first authentication data correspond to the authentication data expected, the gateway receives from the provisioning server a description including, for each communication device among a set of communication devices liable to pairing with the second secure wireless local network:
a communication device identifier,
a network identifier, and
authentication data expected vis-à-vis the first secure wireless local network;
and wherein the gateway creates one said first secure wireless local network for each communication device among said set of communication devices liable to pairing with the second secure wireless local network, by allocating to said first secure wireless local network the network identifier of the description of the corresponding communication device.

2. The pairing method according to claim 1, wherein, when the second pairing with the second secure wireless local network for a communication device among said set of communication devices liable to pairing is confirmed, the gateway stops the first secure wireless local network created for said communication device.

3. The pairing method according to claim 1, wherein each first secure wireless local network and the second secure wireless local network are of the Wi-Fi type.

4. (canceled)

5. A non-transitory information storage medium storing a computer program comprising instructions for implementing, by a processor, the method according to claim 1, when said program is executed by said processor.

6. A gateway configured to serve as a wireless access point to at least one first secure wireless local network and to a second secure wireless local network, the gateway interconnecting the second secure wireless local network and a wide-area network so that each communication device paired with the second secure wireless local network can access services offered via the wide-area network, a provisioning server being connected to the wide-area network, the gateway comprising circuitry configured for:
detecting an attempt at first pairing of a communication device with one said first secure wireless local network, in which the communication device is identified and supplies first authentication data;
checking that the first authentication data correspond to authentication data expected by the gateway vis-à-vis said first secure wireless local network;
confirming, in the case of a positive check, the first pairing with said first secure wireless local network and transmitting to said communication device via said first secure wireless local network second authentication data as well as a network identifier of the second secure wireless local network;
detecting an attempt at second pairing of the communication device with the second secure wireless local network, in which the communication device supplies other authentication data;
checking that said other authentication data correspond to said second authentication data; and
confirming, in the case of a positive check, the second pairing with the second secure wireless local network, so as to enable said communication device to access said services offered via the wide-area network,
wherein the first secure wireless local network does not enable to access the services offered via the wide-area network, and for confirming the first pairing with said first secure wireless local network, the circuitry is further configured for:
checking with the provisioning server that said communication device is associated with the same user as the gateway,
and, for checking that said communication device is associated with the same user as the gateway and to check that the first authentication data correspond to the authentication data expected, the circuitry is further configured for receiving from the provisioning server a description including, for each communication device among a set of communication devices liable to pairing with the second secure wireless local network:
a communication device identifier,
a network identifier, and
authentication data expected vis-à-vis the first secure wireless local network;
and the circuitry is further configured for creating one said first secure wireless local network for each communication device among said set of communication devices liable to pairing with the second secure wireless local network, by allocating to said first secure wireless local network the network identifier of the description of the corresponding communication device.
